(19) United States
(12) Patent Application Publication
(10) Pub. No.: US 2006/0265312 A1
(43) Pub. Date: Nov. 23, 2006

(54) Online real estate auctions

(76) Inventors: Spencer Rascoff, Seattle, WA (US); Scott Bekemeyer, Menlo Park, CA (US); Lloyd Frink, Seattle, WA (US); Kristin Acker, Seattle, WA (US); Jorrit Van der Meulen, Seattle, WA (US); Chloe Harford, Seattle, WA (US)

Correspondence Address: PERKINS COIE LLP;PATENT-SEA, P.O. BOX 1247, SEATTLE, WA, 98111-1247, US

(21) Appl. No.: 11/378,620

(22) Filed: Mar. 17, 2006

Related U.S. Application Data
(60) Provisional application No. 60/663,093, filed on Mar. 18, 2005.

(51) Int. Cl. G06Q 40/00

(52) U.S. Cl. 705/37

(57) ABSTRACT

A facility for conducting a real estate auction having a number of participants is described. Each of the participants uses a participant computing system or similar device. The facility receives bidding instructions from participants, and transmits auction status updates to each of the participant computing systems.

### CROSS-REFERENCE TO RELATED APPLICATION

This application claims benefit of U.S. Provisional Application No. 60/663,093, filed Mar. 18, 2005, which is hereby incorporated by reference in its entirety.

### TECHNICAL FIELD

The described technology is directed to the field of Internet commerce.

### BACKGROUND

Real estate auctions enable the owner of a property to sell the property at a price determined by a competitive bidding process occurring between multiple prospective purchasers. Such auctions are typically conducted either in person, such that the auctioneer conducting the auction and the bidders are all in the same location during the auction, or by telephone, such that each bidder places a telephone call to the auctioneer conducting the auction.

In-person auctions have the advantage that they typically provide a rich body of status information to each participant throughout the course of the auction, in the each participant can personally observe all of the interactions between the participants and the auctioneer. The use of an in-person auction can limit the set of participants to those who are able to be physically present at the auction, however, which may in turn limit the sale price produced by the auction.

Telephone auctions have the advantage that virtually anyone can participate, irrespective of his or her physical location. Unfortunately, the status information typically provided to participants during the course of a telephone auction can be quite limited, making it difficult for some participants to completely appreciate what is happening during the auction, and potentially limiting their level of bidding and reducing their level of satisfaction with the auction.

In view of the shortcomings of conventional real estate auction formats discussed above, techniques for conducting more effective real estate auctions would have significant utility.

### BRIEF DESCRIPTION OF THE DRAWINGS

FIG. 1 is a high-level data flow diagram showing data flow within a typical arrangement of components used to provide the facility.

FIG. 2 is a block diagram showing some of the components typically incorporated in at least some of the computer systems and other devices on which the facility executes.

FIG. 3 is a flow diagram showing steps typically performed by the facility to maintain the status of the auction throughout the auction process.

FIG. 4 is a flow diagram showing steps typically performed by the facility in order to disseminate the status of an auction.

FIG. 5 is a display diagram showing a sample display presented by the facility to disseminate the status of an auction via the Internet.

FIG. 6 is a display diagram showing a display presented by the facility in order to collect bidding instructions and disseminate auction status via the web.

### DETAILED DESCRIPTION

A software facility for conducting a real estate auction over the Internet (“the facility”) is described. In some environments, the facility both receives bids from participants and displays real-time or near-real-time status of the auction to each participant via the World Wide Web (“the web”). In some embodiments, the facility receives bids from participants via a telephone connection, and displays real-time or near-real-time status of the auction to each participant via the web.

In some embodiments, the facility uses a Japanese auction model, also called “up-the-ladder,” in which the auctioneer announces increasing bid amounts—such as at increments of $20,000—and every participant can choose whether to subscribe to the current bid amount. (Each new bid amount is said to correspond to a new “round.”) The number of participants who subscribe typically declines as the bid amount increases, until a bid amount is reached that is subscribed to by only a single participant. This participant wins the auction, and pays the seller that amount.

In some embodiments, when a “ceiling” bid amount is reached that had zero subscribers immediately after a bid amount that had multiple subscribers, the facility switches to a “down the ladder” auction model to conclude the auction. In such cases, the facility reduces the ceiling bid amount by smaller increments than separated the increasing bid amounts—such as at increments of $2,000—until one purchased it subscribes to the current bid amounts.

In some embodiments, when the down the ladder auction model reaches a “floor” bid amount to which multiple participants subscribe, the facility switches to an “up the ladder” auction model to conclude the auction. In such cases, the facility typically increases the floor bid amount by smaller increments than separated the decreasing bid amounts—such as at increments of $500.

By conducting a real estate auction in some or all of the manners described above, the facility enables participants in a wide range of geographic locations to participate in the auction, while providing rich feedback about the status of the auction that permits each participant to participate fully and have a relatively high degree of satisfaction with the auction.

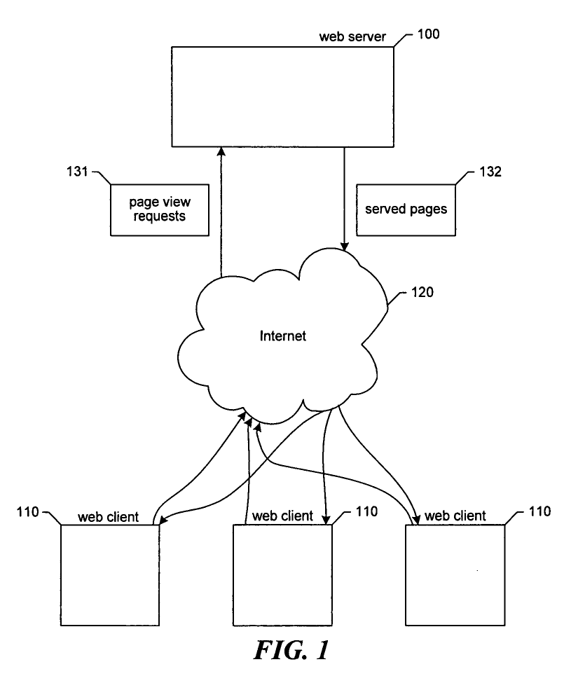

FIG. 1 is a high-level data flow diagram showing data flow within a typical arrangement of components used to provide the facility. A number of web client computer systems 110 that are under user control generate and send page view requests 131 to a logical web server 100 via a network such as the Internet 120. These requests typically include page view requests and other requests of various types relating to disseminating status information about a real estate auction and/or receiving bidding instructions from auction participants. Within the web server, these requests may either all be routed to a single web server computer system, or may be loaded-balanced among a number of web server computer systems. The web server typically replies to each with a served page 132.

While various embodiments are described in terms of the environment described above, those skilled in the art will appreciate that the facility may be implemented in a variety of other environments including a single, monolithic computer system, as well as various other combinations of computer systems or similar devices connected in various ways. In various embodiments, a variety of computing systems or other different client devices may be used in place of the web client computer systems, such as mobile phones, personal digital assistants, televisions, cameras, etc.

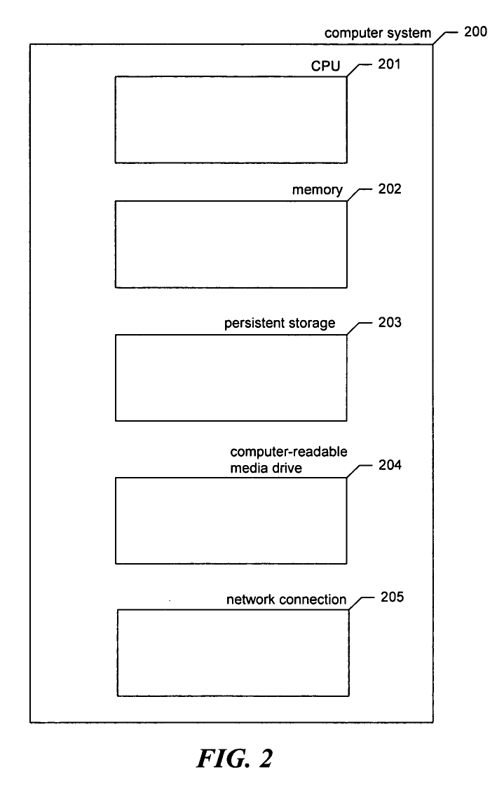

FIG. 2 is a block diagram showing some of the components typically incorporated in at least some of the computer systems and other devices on which the facility executes. These computer systems and devices 200 may include one or more central processing units (“CPUs”) 201 for executing computer programs; a computer memory 202 for storing programs and data while they are being used; a persistent storage device 203, such as a hard drive for persistently storing programs and data; a computer-readable media drive 204, such as a CD-ROM drive, for reading programs and data stored on a computer-readable medium; and a network connection 205 for connecting the computer system to other computer systems, such as via the Internet. While computer systems configured as described above are typically used to support the operation of the facility, those skilled in the art will appreciate that the facility may be implemented using devices of various types and configurations, and having various components.

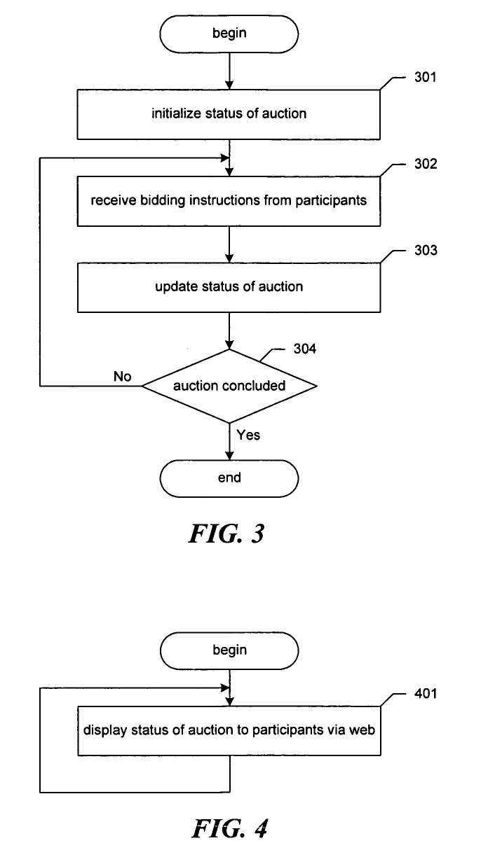

FIG. 3 is a flow diagram showing steps typically performed by the facility to maintain the status of the auction throughout the auction process. In step 301, the facility initializes the status of the auction, such as by establishing an initial round of the auction having a particular starting price. In step 302, the facility receives bidding instructions from participants. As discussed below, participants may submit bidding instructions either using the user interface provided by the facility to transmit them via the Internet or another network, or by specifying them in a telephone conversation with a representative of the auctioneer who inputs the bidding instructions for receipt by the facility, or by keying in a sequence of telephone keypresses that are decoded by the facility. In step 303, the facility updates the status of the auction, such as by identifying the set of bidders who have subscribed to the current round, and, based upon the contents of this set, determining whether a new round should be initiated and what its bid amount should be. The facility typically performs step 303 based upon rules and other procedures adopted by the auctioneer for the auction. A representative example of such rules and procedures is included below. In step 304, if the auction has concluded based upon the status update performed in step 303, then these steps conclude, else the facility continues in step 302 to receive additional bidding instructions from participants.

Those skilled in the art will appreciate that the steps shown in FIG. 3 and in each of the flow diagrams discussed below may be altered in a variety of ways. For example, the order of the steps may be rearranged; substeps may be performed in parallel; shown steps may be omitted, or other steps may be included; etc.

FIG. 4 is a flow diagram showing steps typically performed by the facility in order to disseminate the status of an auction. The facility typically performs the steps shown in FIG. 4 in parallel with those shown in FIG. 3, although in some embodiments the facility performs the steps of FIG. 4 in a manner that is more rigorously synchronized with the steps of FIG. 3. In step 401, the facility displays the status of the auction to the participants via the web. In some embodiments, the facility does so using a user interface such as one of the user interfaces depicted and described herein. After step 401, the facility continues in step 401 to reiteratively perform this step.

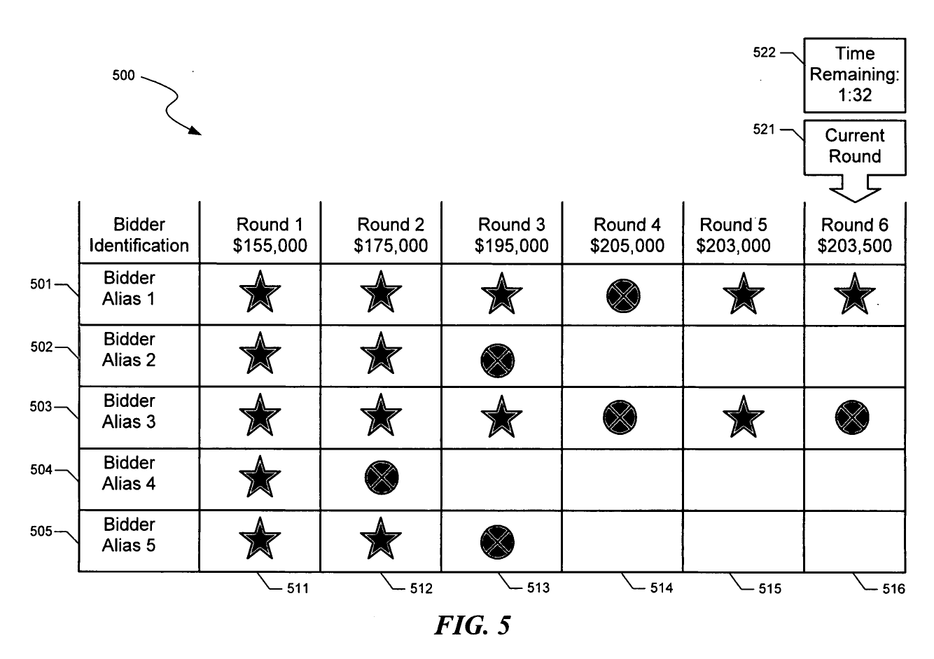

FIG. 5 is a display diagram showing a sample display presented by the facility to disseminate the status of an auction via the Internet. The display 500 includes a table, made up of rows 501-505, each corresponding to a different auction participant, or “bidder.” For example, row 501 corresponds to a bidder having the bidder identification “bidder alias 1.” Each row of the tables is divided into a number of columns 511-516 each corresponding to a different round of the auction having a different bid amount. For example, column 512 corresponds to the second round of the auction, having the bid amount $175,000. Each intersection of a row and column indicates whether the bidder associated with the row bid in the round associated with the column. For example, a star at the intersection of row 502 and column 512 indicates that the bidder “bidder alias 2” bid in round 2, while a circled X at the intersection of row 502 and 513 indicates that the bidder “bidder alias 2” did not bid in round 3. The display further includes a current round indicator 521 pointing to the column associated with the current round, and a time remaining indicator 522 indicating the amount of time remaining for participants to bid in the current round.

The example relates to a scenario where a price limit is met at $205,000 and bidding continues at a lower price, and finally ends at $203,500. In some embodiments, the user interface accommodates one or more of the following:
a. Unlimited number of bidders: in some embodiments, the user interface is as long as necessary to accommodate more rows, and the page scrolls vertically to show all of the rows.
b. As bidders drop out, the number of rows reorders to show the active bidders at the top.
c. Unlimited number of rounds: the user interface scrolls horizontally to accommodate an unlimited number of columns, such that only the latest rounds appear.
d. The facility indicates bidder's response with by a symbol of one of two types: bidder is in (star) and bidder is out (circled x).
e. A bid round indicator identifies the current round, and a bid round timer displays the time remaining before the end of the round.
f. When the round opens, the asking amount is displayed in the round header.
g. The bid amount for the round is set by the auctioneer, and is displayed when the round begins.
h. The current round does not indicate bidding results until the round closes.
i. The page refreshes automatically, such as once per second, to update the data presented.

In some embodiments, the facility permits the bidder responses to be keyed in via the phone, recorded by conference call software, and displayed to the auctioneer through a web-based application.

In some embodiments, the facility permits bidders to submit their bids by voice in a conference call environment in lieu of the phone keypad.

In particular, bidders call into the conference call. The conference call software lists the number of participants, their names, and their status. The auctioneer speaks to the participants over the conference bridge while all participants are muted. The auctioneer asks for bids at a certain price and bidders are asked to “queue up” by pressing “*9” on their phone. The call software indicates which bidders are ready and in the queue. The conference operator sub-conferences each bidder individually and records his or her decision. The operator asks if they are willing to subscribe to the current bid amount, and the bidders each state “yes” or “no” to the operator. Once the operator has spoken to the bidder, the bidder is removed from the queue.

This process leaves no doubt in the bidder's mind that his or her bid was recorded. Also, in some embodiments, the conversations with the operator are recorded. This approach also resolves the issue of bidders keying the wrong numbers, or changing their keyed answer after it has been recorded by the facility. Bidders can re-enter the queue if they wish to change their answer.

Once the operator has gotten answers from all the bidders, the auctioneer announces the close of the round, and bidders can no longer enter the queue. This process is repeated for each round, and the results are posted to the facility site.

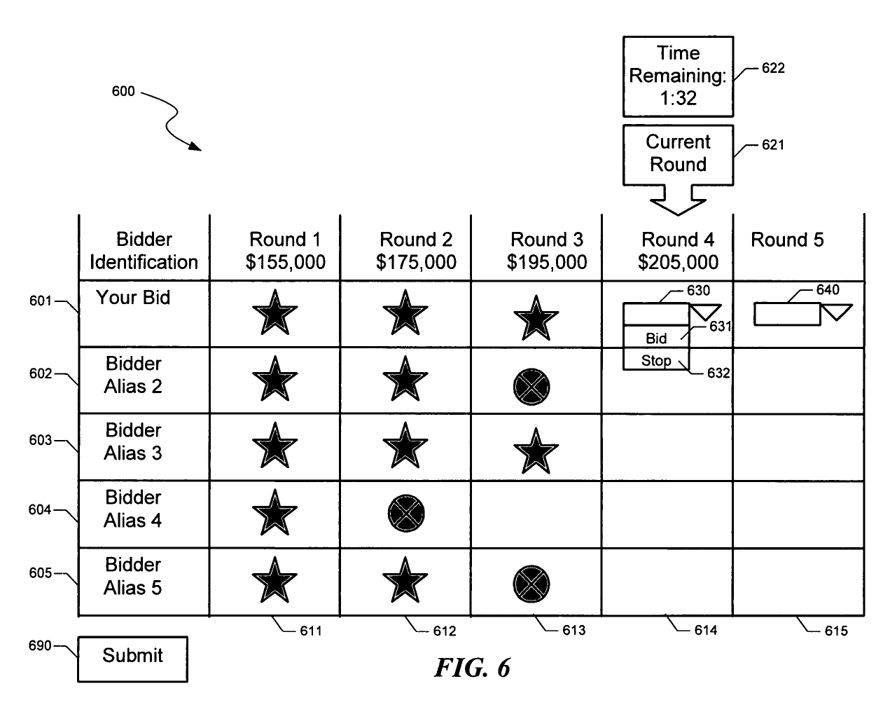

FIG. 6 is a display diagram showing a display presented by the facility in order to collect bidding instructions and disseminate auction status via the web. This display is similar to display 500 shown in FIG. 5, but adds bidding controls. Here, row 601 corresponds to the participant to whom display 600 is presented. In column 614 and 615, row 601 contains controls that this bidder may use in order to submit a bidding instruction for the current round. In particular, row 614 contains a bidding control 630 that the participant currently may use to submit a bidding instruction for round 4. The participant can select either a bid option 631 or a stop option 632. When the participant selects one of these options, and the user subsequently selects the submit button 690, his or her computer system transmits it to the auction server computer system, and it is reflected in column 614 after round 4 closes, along with the bidding instructions of the other surviving bidder to whom row 603 corresponds. If both of the two remaining participants in round 4 send bidding instructions to bid in round 4, then the bidding instruction control 640 for round 5 in column 615 becomes active, and the participant may again select either the bid or the stop option.

Additionally, in some embodiments:
a. The facility requires users to log in to the site prior to reaching this bidding display page.
b. The user's bid information appears in the top row.
c. A dropdown list contains the choices for each round. These include “bid” and “stop.” The last round with a “bid” will indicate the highest bid for a bidder.
d. The participant uses the submit button to submit his or decision. This process is repeated for each new round.
e. Once a bid has been submitted for a round each participant's page is updated. A participant can resubmit their decision an unlimited time.
f. Once the round ends, no more submissions can be made for that round. The last submission by the participant will be saved and displayed.
g. The bid information for other bidders will not be displayed until the round ends.

Sample Auction Process.

1. Bidder Registration:

Bidders register either online or at open houses. In order to register, bidders must provide their:
a. Name
b. Phone number (preferably with back-up number as well)
c. Letter of pre-qualification or pre-approval from lender
d. Name of buy-side broker and company affiliation of broker, if any. If no broker, we need to have them sign a statement to that effect.

2. Auction:

The facility will conduct auction. General rules are as follows:

All registered bidders participating via telephone call the specified number at auction time. The facility will allow a reasonable grace period (5 minutes) if all bidders are not signed in at auction time and will attempt to contact the registered bidders who are not present.

The auctioneer will provide final set of instructions about auction process. After instructions are started, no new bidders will be allowed to participate in auction.

Bidding will be conducted in a modified Japanese Auction format with successive rounds. Bidders advance by “opting in” by round. The facility will determine the bid increments between rounds. As an example, the facility may use increments of $25,000 and a starting bid of $450,000.

If no bidders advance to the next round, the bid increment will be lowered until at least one bidder advances.

The facility retains the right to cancel, postpone, or extend auction at any time and for any reason.

Highest dollar value wins auction. However, seller is not obligated to accept any offer, and seller could accept an offer that is not the highest dollar amount. In various embodiments, the facility does or does not price contingencies.

After every round, the facility's website will be updated with status following bidders' action.

If necessary, the facility will conduct a “Down the Ladder” and potentially a subsequent “Up the Ladder” auction to determine the first and second place bidders. This will occur when the first and/or second place bidders can not be identified through bidding by the facility's chosen bid increments.

For example, in hypothetical Round 7, two bidders remain after both “opt in” at a $450,000 price. In Round 8, the facility increases the bid price to $475,000 and neither bidder opts in. The facility will then offer a bid price of $474,000 to both parties and will continue to decrease the bid price by a small increment until one or both bidders opt in. If one bidder opts in at $474,000, then that bidder wins the auction, and the back-up bid is $450,000.

If both bidders opt in at $474,000, then a new floor price is established. The facility will then go back up the ladder and offer a new bid price of $474,500. The facility will continue in this fashion until a winning bid is determined.

Bidders should remain on the phone even if they are not the high bidder in order to remain in contention for second place. Depending on the auction dynamics, a large number of bidders may be eligible to bid in a “Down the Ladder” auction to determine the back-up bid.

Auction process is complete when the facility has established winning and back-up bids.

3. Post-Auction:

If seller is willing to accept the offer, proceed with settlement and closing process.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A method in a computing system for conducting a real-time or near-real-time real estate auction having a plurality of participants, each of the plurality of participants using a participant computer system, comprising:
for each of a series of auction rounds:
automatically determining a bid amount for the round;
causing each of the participant computer systems to display an indication of the bid amount for the auction round;
soliciting bidding instructions from at least a subset of the participants;
receiving from at least a subset of the participant computer systems one or more bidding instructions; and
resolving the auction in accordance with the received bidding instructions.

2. The method of claim 1, further comprising causing each of the participant computer systems to display an indication of a subset of participants who have subscribed to the current bid amount.

3. The method of claim 1 wherein the bid amount is determined and bidding restrictions are solicited in accordance with a Japanese auction model.

4. The method of claim 1 wherein the bid amount is determined and bidding restrictions are solicited in accordance with a Japanese auction model, followed by a down the ladder auction model.

5. The method of claim 1 wherein the bid amount is determined and bidding restrictions are solicited in accordance with a Japanese auction model, followed by a down the ladder auction model, followed by an up the ladder auction model.

6. An apparatus for conducting an auction having a plurality of participants, each of the participants having a participant electronic communications device, comprising:
an auction direction component that provides bidding opportunities to participants in accordance with a Japanese auction model;
a receiving component that receives bidding instructions at a central geographic location from participant electronic communications devices each operated by a participant among the plurality of participants; and
a sending component that transmits auction status updates from the central geographic location to each of the participant electronic communications devices.

7. The apparatus of claim 6 when the receiving component receives bidding instructions transcribed from spoken instructions received from participants via telephone calls.

8. The apparatus of claim 6 when the receiving component decodes bidding instructions from telephone keypress sequences received from participants via telephone calls.

9. The apparatus of claim 6 when the receiving component receives bidding instructions from the participant electronic communications devices operated by participants.

10. The apparatus of claim 6 wherein at least one of the participant electronic communications devices is a computer system.

11. The apparatus of claim 6 wherein at least one of the participant electronic communications devices is a mobile phone.

12. The apparatus of claim 6 wherein at least one of the participant electronic communications devices is a television.

13. The apparatus of claim 6 wherein at least one of the participant electronic communications devices is a personal digital assistant.

14. The apparatus of claim 6 wherein the auction component provides bidding opportunities to participants in accordance with a pure Japanese auction model.

15. The apparatus of claim 6 wherein the auction component provides bidding opportunities to participants in accordance with a hybrid Japanese auction model that comprises a first up-the-ladder phase, followed by a down-the-ladder phase, followed by a second up-the-ladder phase.

16. A computer-readable medium whose contents cause a computing system to perform a method for conducting a real estate auction having a plurality of participants, each of the participants using a participant computer system, the method comprising:
for each of a series of auction rounds:
automatically deferring a bid amount for the round;
causing each of the participant computer systems to display an indication of the bid amount for the round;
receiving from at least a subset of the participant computer systems one or more bidding instructions; and
resolving the auction in accordance with the received bidding instructions.

17. The computer-readable medium of claim 16 wherein the method further comprises causing each of the purchased in computer systems to display an indication of a subset of participants who have subscribed to the current bid amount.

18. The computer-readable medium of claim 16 wherein the bid amount is determined in accordance with a Japanese auction model.

19. The computer-readable medium of claim 16 wherein the bid amount is determined in accordance with a Japanese auction model, followed by a down the ladder auction model.

20. The computer-readable medium of claim 16 wherein the bid amount is determined in accordance with a Japanese auction model, followed by a down the ladder auction model, followed by an up the ladder auction model.

21. One or more generated data signals collectively conveying a real estate auction status display data structure between an auction computing system and an auction participant computing system, comprising:
contents constructed to cause the auction participant computing system to display an indication of a distinguished bidding round established by an auction organizer;
contents constructed to cause the auction participant computing system to display an indication of a bid amount for the distinguished bidding round selected by the auction organizer; and
contents constructed to cause the auction participant computing system to display an indication of the number of auction participants that have subscribed to the distinguished bidding round.

22. The data signals of claim 21, wherein the distinguished bidding round is a current bidding round.

23. The data signals of claim 21, wherein the distinguished bidding round is a most recent bidding round.
